(19) United States
(12) Patent Application Publication
(10) Pub. No.: US 2009/0260527 A1
(43) Pub. Date: Oct. 22, 2009

(54) Apparatus of making and storage of yogurt with thermoelectric technology

(75) Inventors: Yushen Qian, Monroe Township, NJ (US); Sen Liang, Shanghai (CN); Li Wei Tan, Shanghai (CN); Yao Chen, Shanghai (CN); Ziye Qian, Monroe Township, NJ (US)

Correspondence Address: Ziye Qian, 8 Regina Drive, Monroe Township, NJ, 08831, US

(73) Assignee: ACU-MED Technology LLC, Monroe Township, NJ (US)

(21) Appl. No.: 12/148,110

(22) Filed: Apr. 17, 2008

(51) Int. Cl. A23C 9/123; A23C 3/02

(52) U.S. Cl. 99/453

(57) ABSTRACT

A machine can be used as a yogurt maker, warm appliance and refrigerator in the household, consists of: a thermally insulated fermentation compartment, a thermocouple or a temperature sensor, a thermoelectric assembly, a selective function switch, a safety door switch, a controller, and at least one milk container. Such units, controlled through pre-programmed cycles, can perform a variety of tasks: It is able to automatically prepare yogurt by distributing transformation culture into milk following the gradual warming, incubation and natural cooling processes; fermentation time is automatically set according to the load production and environment temperature; afterwards, maintain yogurt with cold temperature for extended periods of time.

### CROSS REFERENCE

U.S. PATENT DOCUMENTS

| | | | |
|---|---|---|---|
| 3,685,153 | August 1972 | Borkton | |
| 3,975,239 | August 1976 | Stamer | 435/800 X |
| 4,009,368 | February 1977 | Faivre et al | |
| 4,163,472 | August 1979 | Taylor | 99/453 |
| 4,195,561 | April 1980 | Castanis | |
| 5,013,158 | May 1991 | Tarlow | 99/348 X |
| 5,829,344 | November 1998 | Landé | 99/453 |
| 5,896,811 | April 1999 | Yaow et al | 99/453 |
| 5,979,300 | November 1999 | Donovan | 99/323 |
| 6,280,781 | August 2001 | Landé | 426/34 |
| 6,571,690 | June 2003 | Hsu | 99/453 |
| 20080066628A1 | March 2008 | Qian | 99/453 |

FOREIGN PATENT DOCUMENTS

| | | |
|---|---|---|
| 57091151 | February 1976 | Japan |

### BACKGROUND OF THE INVENTION

The current methodology of homemade yogurt preparation machines on the market involves tedious boiling of fresh milk, cooling down to specified temperatures that accommodate survival of active cultures, addition and subsequent mixing of the culture in milk, or using pasteurized milk mixing with active cultures, compartmentalization of the milk into sterilized containers, and incubation of milk inside these containers at 38° C.-46° C. for 7 to 12 hours depending on the loading and environment temperature. Following the successful transformation of milk into yogurt, it is necessary to first cool them at room temperature and store within a refrigerator.

However, several flaws are associated with the above process:
The milk must often be manually heated to boiling and cool down—both time inefficient processes.
Following incubation, one must allow yogurt to equilibrate at room temperature, and then store within a refrigerator.
When the yogurt maker is not in use, it presents no alternative functionality.
Manual loading and unloading of incubator and refrigerator increase the chance of contamination.
Yogurt will denature if time and temperature settings are not at optimal setting conditions. Overcooking causes yogurt tart, otherwise milk can not be firm.

There are two types of yogurt makers: one requires manual heating of the milk and addition of culture; the second type uses electrical thermal heater to warm cultured milk to set temperatures. However, both these types of yogurt makers require manual handling of containers and/or pots. Furthermore, contamination is likely since the natural cooling of yogurt in the room temperature environment may present optimal conditions for growth of undesired bacteria. If person put yogurt containers in the room temperature too long, yogurt will be denatured too.

The proposed invention utilizes a novel mechanism in order to circumvent these problems. The machine is capable of running automated cycles that have been optimized and programmed. Thus, the benefits include reduced contamination, automated process timing determination, self-efficiency, as well as the other functionalities as a refrigerator or a kitchen warm appliance.

### SUMMARY OF THE INVENTION

The purpose of this invention is to provide an affordable household yogurt maker with the thermoelectric assembly. Whenever this novel machine has completed making yogurt, it will automatically switch to its secondary function as a refrigerator. The fermentation time of process will be adjusted by loading and environment temperature automatically.

Regarding the process, the machine achieves an increase in temperature without overheating the active culture by using: a thermoelectric assembly with both side heat/cold sinks and fans; a thermally insulated compartment; a fan to maintain air flow and temperature homogeneity in the fermentation compartment. During incubation, the machine will keep temperature constant at 42° C. through PID (Proportional Integral Derivative) controlling so that air temperature will not be affected by outside environment temperature and production load.

Regarding the machine's secondary purpose as a refrigerator, cooling is achieved through the same thermoelectric assembly with a reversed DC (direct current) polarity wiring configuration. This will export heat from the fermentation compartment and maintain cold temperature in it.

Furthermore, the machine can also be used as a kitchen warm appliance.

### DESCRIPTION OF THE DRAWINGS

For more complete understanding of the present invention, and the advantages thereof, the list of drawings and brief written descriptions are given as following:

FIG. 1 is a schematic view of the proposed invention.

FIG. 2 is a time-wise change of the milk temperature during the fermentation process.

FIG. 3 is an isometric view of the thermoelectric assembly.

FIG. 4 is a view of the thermoelectric assembly installed on the wall of fermentation compartment.

FIG. 5 is a schematic view of the proposed invention with an extra heating system and an extra vapor compression cooling system.

### DETAILED DESCRIPTION

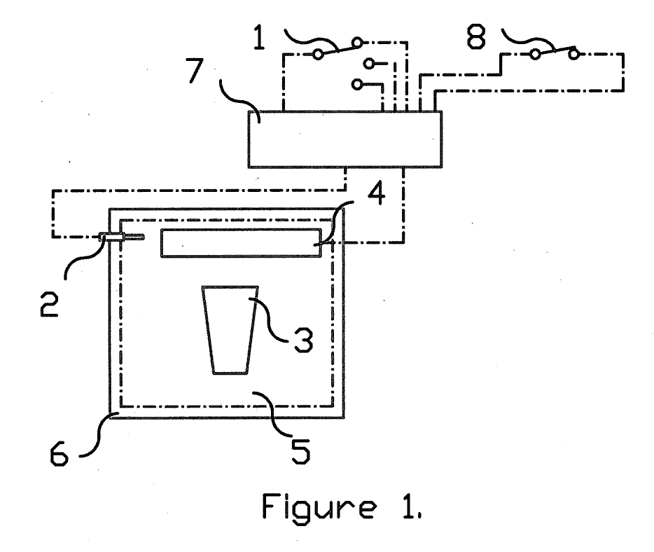

The preferred embodiments of the present invention and the advantages are best described by referring to FIGS. 1 through 5 of the drawings. The proposed invention device is capable of performing under three functional modes: yogurt maker, refrigerator, and warm appliance. People can use mode switch 1 to select the desired function.

Referring to FIG. 1, the present invention is composed of a three-function switch 1, a safety switch 8, a process controller 7, a thermocouple or a temperature sensor 2, container(s) 3 with cultured milk, a thermally insulated housing 6, which builds a fermentation compartment 5, and a thermoelectric assembly 4 installed on the back or top of the wall in the compartment 5.

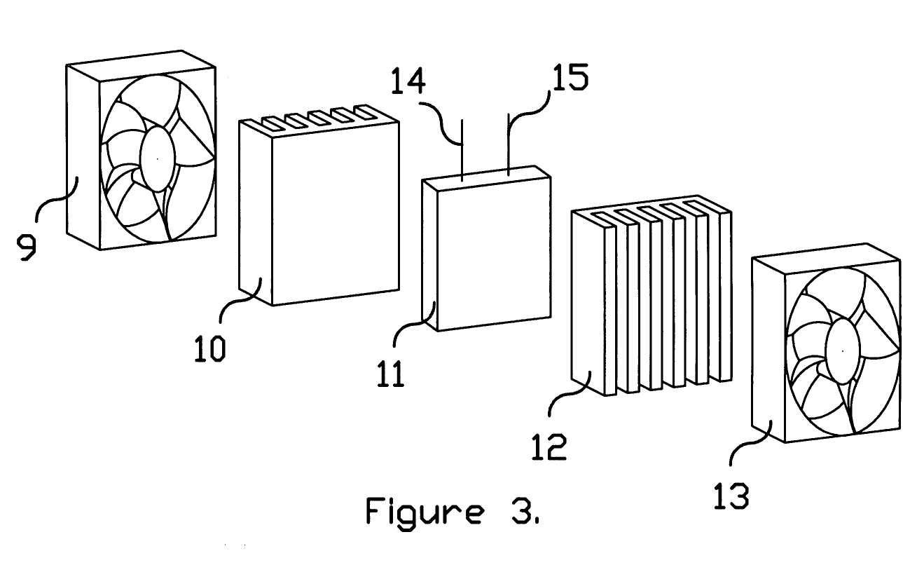

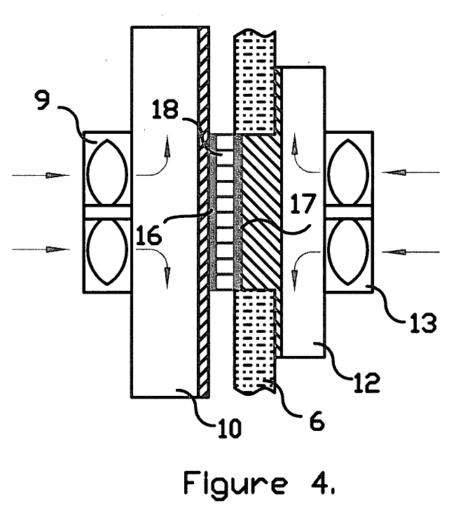

The machine operates through two primary mechanisms: Heating and cooling utilize the same thermoelectric assembly 4, which includes air fans 9 and 13, hot/cold sinks 10 and 12, hot/cold plates of thermoelectric device 16 and 17, an array of thermocouples 18, that the thermoelectric element 11 is composed of hot/cold plates 16, 17 and an array of thermocouples 18, and a pair of DC positive/negative wiring connectors 14 and 15 in accordance with FIG. 3 and FIG. 4.

The mechanism of thermoelectric element 11 as heating is applied to fermentation and warm processes. It is achieved by using: the thermoelectric element 11 serves as an electrical heater with DC polarity wiring, in such condition pole 14 is connected with the positive connector of DC power supply with 12 VDC usually and pole 15 is connected with the negative connector of DC power supply, finger sink 12 works as hot sink secured to the hot plate 17 of thermoelectric element 11, and finger sink 10 works as cold sink secured to the cold plate 16 of the thermoelectric element 11, the fan 13 does work to transfer heat from hot sink 12 and warm the air in the compartment that serves as a fermentation compartment 5, meanwhile the fan 13 runs during all processes to promote air temperature homogeneity in the compartment 5. The fan 9 works to transfer heat from environment air to the finger sink 10 at the same time. In such scenario, the thermoelectric assembly 4 moving heat energy from outside of fermentation compartment 5 to inside serves as an electrical heater.

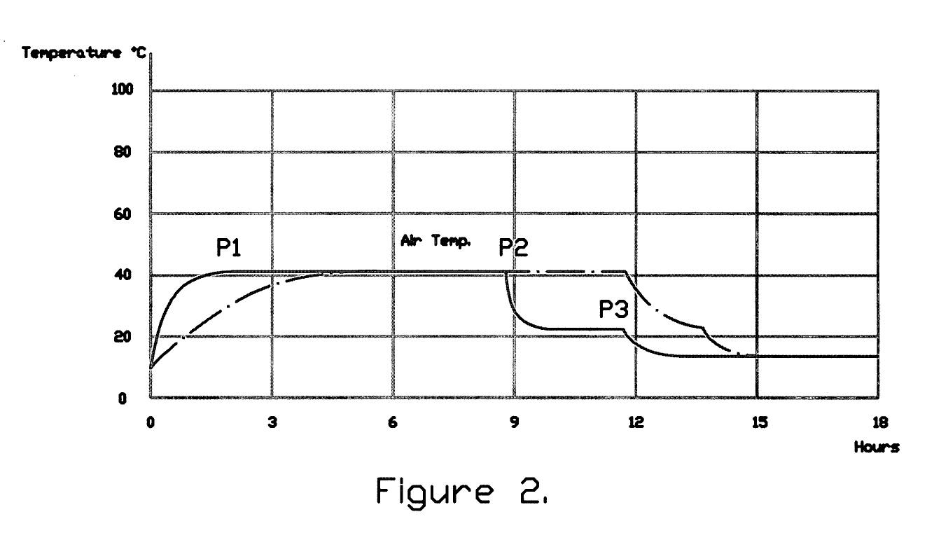

When the mode switch 1 is in yogurt maker position, during the fermentation process, the air temperature in the compartment 5 is monitored by the thermocouple or temperature sensor 2 and will be kept at 42° C. with the PID (Proportional Integral Derivative) technology by the controller 7 in incubation. Because of yogurt preparation with difference of production load and environment temperature, the present invention has the following written process time settings: Gradual warming process, at the beginning of yogurt preparation, the air in the compartment 5 is being warmed by the thermoelectric assembly 4 gradually, the controller 7 monitors the air temperature with the help of sensor 2 and dose not count the time until the air temperature reaches 42° C. Incubation process, the sensor 2 informs controller 7 the temperature readout in the compartment 5 and the controller 7 controls the thermoelectric assembly 4 on and off to warm the air temperature and keeps it at 42° C. for the setting time. Natural cooling process, according to FIG. 2., at the beginning, due to the difference of heat inertia influenced by loading and environment temperature which affects the dissipation of heat energy on the thermoelectric assembly 4 and housing 6, the controller 7 monitors the drop in air temperature in the compartment 5 for the setting time. Then the controller 7 adjusts the total time of the natural cooling process. The more the load, the shorter the time of the natural cooling process; the higher the environment temperature, the longer the time of the natural cooling process. Afterwards, the controller 7 automatically switches the machine to serve its secondary refrigerator function. The sum of time for gradual warming, incubation and natural cooling processes is defined as fermentation time, as presented in FIG. 2, it is adjusted automatically by controller 7 depending on the production load and environment temperature.

The second mechanism of cooling, which is used to serve as a refrigerator, is achieved by using: the same thermoelectric element 11 serves as an electrical cooler with DC polarity wiring, in such condition pole 14 is connected with the negative connector of DC power supply and pole 15 is connected with the positive connector of DC power supply, finger sink 12 works as cold sink secured to the cold plate 17 of the thermoelectric element 11, and finger sink 10 works as hot sink secured to the hot plate 16 of the thermoelectric element 11, the fan 13 does work to dissipate heat from the air in the compartment 5 on the cold sink 12, and fan 9 works to aid in removing heat from the finger sink 10 to environment air at the same time. In such scenario, the thermoelectric assembly 4 moving heat energy from inside of fermentation compartment 5 to outside serves as an electrical cooler. The controller 7 does not count the time during the refrigeration.

This invention also possesses a tertiary function as a kitchen or a bio-warm appliance, which uses the same mechanism of the thermoelectric assembly 4 as heater to keep the air temperature in the compartment 5 at a setting value, and fan 13 runs to promote air temperature homogeneity inside.

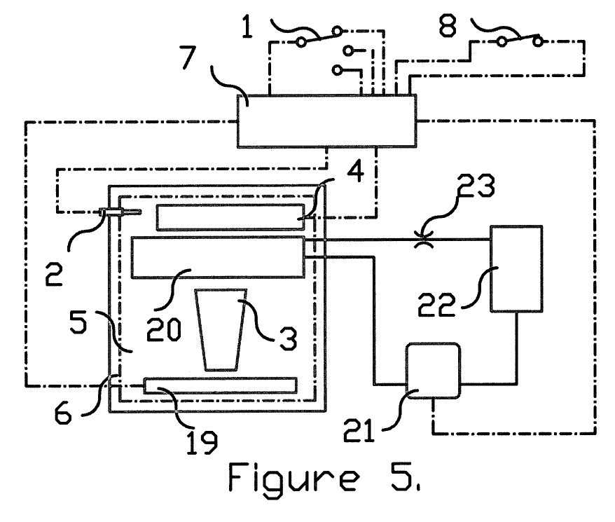

Referring to FIG. 5 the embodiment of the unit has an extra thermal heater 19; one or an array of lamps is installed onto the bottom or on the wall of the compartment 5, which is used to accelerate air heating during the gradual warming process; An extra vapor compression cooling system, which is composed of a compressor 21, a condenser 22, an expansion valve 23 and an evaporator 20, which will accelerate moving heat energy from inside of compartment 5 to outside with the circulation of refrigerant during the refrigeration. This cooling system is very helpful to keep low temperature in the compartment 5, when the environment temperature is higher than 26° C.; so far lot of refrigerators with thermoelectric technology on the market has difficulty to keep the load temperature lower than 5° C. to 10° C.

The present invention claimed is:

1. An automated household yogurt maker is composed of the following: The heating and cooling means includes a fermentation compartment, a thermoelectric assembly, a temperature sensor, which are installed into the said fermentation compartment. A controller with pre-programmed software controls the temperature in the said fermentation compartment during yogurt preparation and refrigeration as well as in warm appliance function.

2. An automated household yogurt maker as claimed 1 has a fermentation process, which includes gradual warming process, incubation process and natural cooling process.

3. An automated household yogurt maker as claimed 1 automatically reverts to refrigeration mode after the end of said fermentation process.

4. An automated household yogurt maker as claimed 1 automatically adjusts the time for yogurt preparation depending on loading and environment temperature.

5. Time of said incubation process as claimed 2 is between 5 to 9 hours.

6. Time of said natural cooling process as claimed 2 is between 1 to 4 hours.

7. An automated household yogurt maker as claimed 1 can switch between three different functionalities: yogurt maker, refrigerator, and warm appliance.

8. An automated household yogurt maker is composed of the following: The heating means includes a said fermentation compartment, a said thermoelectric assembly, an extra thermal heater, a said temperature sensor, which is installed into the said fermentation compartment. A said controller with pre-programmed software controls the temperature in the said fermentation compartment during yogurt preparation and in warm appliance function; The cooling means includes the said fermentation compartment, the said thermoelectric assembly, a said temperature sensor, an evaporator, an expansion valve. Also there are a compressor and a condenser. The controller monitors the temperature in the said fermentation compartment during refrigeration.

9. An automated household yogurt maker as claimed 8 has said fermentation process, which includes said gradual warming process, said incubation process and said natural cooling process.

10. An automated household yogurt maker as claimed 8 automatically reverts to refrigeration mode after said fermentation process.

11. An automated household yogurt maker as claimed 8 automatically adjusts the time for yogurt preparation depending on loading and environment temperature.

12. Time of said incubation process as claimed 9 is between 5 to 9 hours.

13. Time of said natural cooling process as claimed 9 is between 1 to 4 hours.

14. An automated household yogurt maker as claimed 8 can switch between three different functionalities: yogurt maker, small refrigerator, and warm appliance.

15. An automated household yogurt maker as claimed 8 only uses said thermal heater as heating means during yogurt preparation and in warm appliance function.

16. An automated household yogurt maker as claimed 8 only uses said vapor compression system as cooling means during refrigeration.
